(19) United States
(12) Patent Application Publication
(10) Pub. No.: US 2021/0187433 A1
(43) Pub. Date: Jun. 24, 2021

(54) SYSTEM AND PROCESS FOR RECOVERING VALUABLES FROM VENT GAS IN POLYOLEFIN PRODUCTION

(71) Applicant: DALIAN EUROFILM INDUSTRIAL LTD., Dalian, Liaoning (CN)

(72) Inventors: Guodong DU, Dalian (CN); Yanxun MU, Dalian (CN); Ying WANG, Dalian (CN); Peng JIANG, Dalian (CN); Fan WANG, Dalian (CN)

(73) Assignee: Dalian Eurofilm Industrial Ltd., Dalian, Liaoning (CN)

(21) Appl. No.: 16/078,574

(22) PCT Filed: Mar. 20, 2018
(86) PCT No.: PCT/CN2018/079610

§ 371 Date: Aug. 21, 2018

(51) Int. Cl. B01D 53/04; B01D 53/00; B01D 53/22; B01D 53/26; B01D 71/24; B01D 71/04; F25J 3/06; C08F 6/00

(52) U.S. Cl. CPC B01D 53/0438; B01D 2259/652; B01D 53/229; B01D 53/0423; B01D 53/0446; B01D 53/261; B01D 53/226; B01D 71/24; B01D 71/04; F25J 3/06; C08F 6/005; B01D 2253/116; B01D 2256/24; B01D 2256/10; B01D 2257/80; B01D 2257/102; B01D 2259/4009; B01D 2259/403; B01D 53/002

(57) ABSTRACT

A system for recovering valuables from vent gas in polyolefin production is disclosed. The system includes a compression device, a drying device, a condensation and separation device, and a membrane separation device that are connected to each other in sequence. The drying device includes a first adsorption bed and a second adsorption bed which are in parallel connection with each other and in which a desiccant is provided, and a third adsorption bed which is in communication with the first adsorption bed and the second adsorption bed respectively and in which a desiccant is provided. The first adsorption bed and the second adsorption bed are in an adsorption process and a regeneration process alternately, and the third adsorption bed is in an auxiliary regeneration process. A process for recovering valuables from vent gas in polyolefin production is further disclosed. When the system and the process are used, one part of the normal temperature compressed gas stream output by the compression device directly serves as a regeneration gas for regeneration of saturated desiccant in adsorption bed, and it is unnecessary for external supply of regeneration gas, whereby the actual recovery of nitrogen can be effectively improved. Membrane separation technology is combined, and hydrocarbon recovery can be effectively improved as well.

### FIELD OF THE INVENTION

The present disclosure relates to chemical industry, and particularly to a system and a process for recovering valuables from vent gas in polyolefin production.

### BACKGROUND OF THE INVENTION

In monomer purification, polymerization reaction, and degassing of polyolefin resin steps during polyolefin production process, vent gas which comprises a large amount of olefin monomer will be discharged, such as light components stream coming from a top of a degassing bin in monomer purification step, reaction purge gas for controlling inert gas content in polymerization reaction step, and vent gas of degassing bin which is produced after a mixed gas of nitrogen and steam is fed into a degassing bin from a bottom thereof to remove hydrocarbons and make residual catalyst deactivation, in which the content of the vent gas of degassing bin is the largest. All these gases are called as vent gas in polyolefin production, main components of which are nitrogen and olefin monomer, such as propylene, ethylene, butylene and other hydrocarbons, with a certain amount of water vapor. Since hydrocarbons and nitrogen in the vent gas in polyolefin production have very high values, recovery of vent gas is an important step in polyolefin production process. At present, compression, condensation coupling membrane separation process becomes a typical operation during recovery of vent gas in polyolefin production. Since a content of hydrocarbon in the vent gas is relatively low, generally in a range from 7% (V/V) to 40% (V/V), and a critical temperature of hydrocarbon is high which is not easy to condensate, a temperature in a condensation step is generally below 0° C. In order to avoid ice blockage problem in the condensation step, water in the vent gas should be removed first before low temperature condensation step. Therefore, a drying step is necessary.

During practical use, an adsorption bed containing solid desiccant is mostly used for removing water. When the desiccant is saturated after adsorption, the desiccant is regenerated by a heated regeneration gas. The desiccant is recovered and reused; the vent gas generated is discharged to a flare. At present, two-bed drying process is mainly used, in which one bed is in an adsorption process, and the other bed is in regeneration process, heating or cooling. The regeneration gas used in regeneration process is generally the vent gas produced by the subsequent membrane separation process, or the recovered nitrogen/fresh nitrogen. The amount of regeneration gas is generally 40 wt % to 100 wt % of the nitrogen in the original vent gas. Therefore, a large part or all of the nitrogen recovered in the subsequent membrane separation process is used for the regeneration process, resulting in a rather low recovery of nitrogen. Consequently, the nitrogen consumption of polyolefin plant is far higher than expected. Meanwhile, there are a pressure increasing step and a pressure decreasing step during a switching procedure of two beds between the adsorption process and the regeneration process, and thus there is an operation problem of large pressure fluctuation.

Therefore, in a process and a system for recovering valuables from vent gas in polyolefin production in the prior art, hydrocarbons and nitrogen cannot be effectively recovered and reused simultaneously.

### SUMMARY OF THE INVENTION

In order to solve the aforesaid technical problem in the prior art, the present disclosure provides a system and a process for recovering valuables from vent gas in polyolefin production to realize high efficient recovery and reuse of hydrocarbons and nitrogen from vent gas by combination of a compression device, a drying device in which three adsorption beds are provided, a condensation and separation device, and a membrane separation device.

The present disclosure provides a system for recovering valuables from vent gas in polyolefin production, and the system comprises:

a compression device, configured to perform compressing, cooling and separating treatments on vent gas in polyolefin production so as to output a condensed liquid and a normal temperature compressed gas stream;

a drying device, connected to the compression device and configured to perform dehydration treatment on the normal temperature compressed gas stream that is output by the compression device so as to output a dry gas stream;

a condensation and separation device, connected to the drying device and configured to perform cooling and separating treatments on the dry gas stream that is output by the drying device so as to output recovered hydrocarbon and nitrogen stream (hydrocarbon-depleted); and

a membrane separation device, connected to the condensation and separation device and configured to perform separating treatment on the nitrogen stream (hydrocarbon-depleted) that is output by the condensation and separation device so as to output a hydrocarbon-enriched gas stream and a nitrogen-enriched gas stream;

wherein the drying device comprises a first adsorption bed and a second adsorption bed which are in parallel connection with each other and in which a desiccant is provided, a third adsorption bed which is in communication with the first adsorption bed and the second adsorption bed respectively and in which a desiccant is provided, a regeneration gas heater which is in communication with the first adsorption bed and the second adsorption bed respectively, a regeneration gas-liquid separator which is in communication with the first adsorption bed and the second adsorption bed respectively, and a regeneration gas cooler which is in communication with the first adsorption bed and the second adsorption bed respectively, the third adsorption bed being in communication with the regeneration gas heater, and the regeneration gas-liquid separator being in communication with the regeneration gas cooler;

wherein the first adsorption bed and the second adsorption bed are configured to be in an adsorption process and a regeneration process alternately, and the third adsorption bed is configured to be in an auxiliary regeneration process; and

wherein a flow regulation valve is provided on a pipeline to which the first adsorption bed and the second adsorption bed are in parallel connection with each other and is configured to separate the normal temperature compressed gas stream into a first gas stream and a second gas stream, and the second gas stream directly serves as a regeneration gas stream to regenerate saturated desiccant.

According to some specific embodiments, the regeneration process comprises a heating process and a cooling process.

According to some specific embodiments, in the heating process, the second gas stream is treated by the third adsorption bed, the regeneration gas heater, an adsorption bed in the regeneration process, the regeneration gas cooler, and the regeneration gas-liquid separator in sequence, and then treated by an adsorption bed in the adsorption process mixed with the first gas stream so as to output the dry gas stream.

According to some specific embodiments, in the cooling process, the second gas stream is treated by an adsorption bed in the regeneration process, the regeneration gas heater, the third adsorption bed, the regeneration gas cooler, and the regeneration gas-liquid separator in sequence, and then treated by an adsorption bed in the adsorption process mixed with the first gas stream so as to output the dry gas stream.

According to some specific embodiments, a ratio of the second gas stream to the normal temperature compressed gas stream is in a range from 10 wt % to 30 wt %.

According to some specific embodiments, the desiccant is one or more selected from a group consisting of activated alumina, silica gel, and molecular sieve.

According to some specific embodiments, along a flow direction of the vent gas in polyolefin production, the compression device comprises a compressor to perform compressing treatment on the vent gas in polyolefin production so as to meet requirements for operation pressures in condensation separation and membrane separation, a first heat exchanger to perform cooling treatment on the vent gas in polyolefin production after compressing treatment, and a first gas-liquid separator to perform gas-liquid separating treatment on the vent gas in polyolefin production after cooling treatment in sequence.

According to some specific embodiments, along a flow direction of the dry gas stream, the condensation and separation device comprises a second heat exchanger to perform cooling treatment on the dry gas stream and a second gas-liquid separator to perform gas-liquid separating treatment on the dry gas stream after cooling treatment in sequence.

According to some specific embodiments, liquid hydrocarbon flowing from a bottom of the second gas-liquid separator passes through a throttle expansion valve and provides cold energy to the second heat exchanger, and recovered hydrocarbon is output by the second heat exchanger. Noncondensable gas flowing from a top of the second gas-liquid separator provides cold energy to the second heat exchanger, and nitrogen stream (hydrocarbon-depleted) is output by the second heat exchanger.

According to some specific embodiments, the condensation and separation device further comprises external liquid hydrocarbon which provides cold energy to the second heat exchanger, and then recovered hydrocarbon is output by the second heat exchanger.

According to some specific embodiments, the condensation and separation device further comprises a refrigeration unit which is configured to provide cold energy to the second heat exchanger.

According to some specific embodiments, a heat exchanger is one or more selected from a group consisting of a shell-tube heat exchanger, a plate-fin heat exchanger, and a coil-wound heat exchanger.

According to some specific embodiments, the membrane separation device comprises at least one membrane separator in which a membrane module for gas separation is provided.

According to some specific embodiments, when the membrane separation device comprises at least two membrane separators in each of which a membrane module for gas separation is provided, the membrane separators are in series connection to each other along a flow direction of the nitrogen stream (hydrocarbon-depleted) in sequence. The hydrocarbon-enriched gas stream is output from a membrane permeate side of a first membrane separator, and the nitrogen-enriched gas stream is output from a membrane residual side of a last membrane separator.

According to some specific embodiments, the membrane module for gas separation comprises a hydrocarbon selective membrane module and/or a hydrogen selective membrane module.

According to some specific embodiments, the hydrocarbon selective membrane module comprises a hydrocarbon selective membrane, and the hydrocarbon selective membrane is one kind of membrane which is more permeable to hydrocarbon components than to H₂ and N₂. The hydrocarbon selective membrane is preferably a rubbery polymer membrane, such as an organic siloxane polymer membrane.

According to some specific embodiments, the hydrogen selective membrane module comprises a hydrogen selective membrane, and the hydrogen selective membrane is one kind of membrane which is more permeable to H₂ than to N₂ and hydrocarbon components. The hydrogen selective membrane is preferably a glassy polymer membrane, such as polyimide membrane, polyaramide membrane, and polysulfone membrane.

The hydrocarbon selective membrane module and the hydrogen selective membrane module is one or more selected from a group consisting of a spiral-wound membrane module, a plate-frame membrane module, and a hollow fiber membrane module.

According to some specific embodiments, the hydrocarbon-enriched gas stream that is output by the membrane separation device is returned to an inlet of the compressor of the compression device.

According to some specific embodiments, the nitrogen-enriched gas stream that is output by the membrane separation device is returned to a degassing bin of polyolefin plant.

The present disclosure further provides a process for recovering valuables from vent gas in polyolefin production, and the process comprises steps of:

performing, in a compression device, compressing, cooling and separating treatments on vent gas in polyolefin production so as to output a condensed liquid and a normal temperature compressed gas stream;

performing, in a drying device that is connected to the compression device, dehydration treatment on the normal temperature compressed gas stream that is output by the compression device so as to output a dry gas stream;

performing, in a condensation and separation device that is connected to the drying device, cooling and separating treatments on the dry gas stream that is output by the drying device so as to output recovered hydrocarbon and nitrogen stream (hydrocarbon-depleted); and

performing, in a membrane separation device that is connected to the condensation and separation device, separating treatment on the nitrogen stream (hydrocarbon-depleted) that is output by the condensation and separation device so as to output a hydrocarbon-enriched gas stream and a nitrogen-enriched gas stream;

wherein the drying device comprises a first adsorption bed and a second adsorption bed which are in parallel connection with each other and in which a desiccant is provided, a third adsorption bed which is in communication with the first adsorption bed and the second adsorption bed respectively and in which a desiccant is provided, a regeneration gas heater which is in communication with the first adsorption bed and the second adsorption bed respectively, a regeneration gas-liquid separator which is in communication with the first adsorption bed and the second adsorption bed respectively, and a regeneration gas cooler which is in communication with the first adsorption bed and the second adsorption bed respectively, the third adsorption bed being in communication with the regeneration gas heater, and the regeneration gas-liquid separator being in communication with the regeneration gas cooler;

wherein the first adsorption bed and the second adsorption bed are configured to be in an adsorption process and a regeneration process alternately, and the third adsorption bed is configured to be in an auxiliary regeneration process; and

wherein a flow regulation valve is provided on a pipeline to which the first adsorption bed and the second adsorption bed are in parallel connection with each other and is configured to separate the normal temperature compressed gas stream into a first gas stream and a second gas stream, and the second gas stream directly serves as a regeneration gas stream to regenerate saturated desiccant.

According to some specific embodiments, the regeneration process comprises a heating process and a cooling process.

According to some specific embodiments, in the heating process, the second gas stream is treated by the third adsorption bed, the regeneration gas heater, an adsorption bed in the regeneration process, the regeneration gas cooler, and the regeneration gas-liquid separator in sequence, and then treated by an adsorption bed in the adsorption process mixed with the first gas stream so as to output the dry gas stream.

According to some specific embodiments, in the cooling process, the second gas stream is treated by an adsorption bed in the regeneration process, the regeneration gas heater, the third adsorption bed, the regeneration gas cooler, and the regeneration gas-liquid separator in sequence, and then treated by an adsorption bed in the adsorption process mixed with the first gas stream so as to output the dry gas stream.

According to some specific embodiments, a ratio of the second gas stream to the normal temperature compressed gas stream is in a range from 10 wt % to 30 wt %.

According to some specific embodiments, the desiccant is one or more selected from a group consisting of activated alumina, silica gel, and molecular sieve.

According to some specific embodiments, along a flow direction of the vent gas in polyolefin production, the compression device comprises a compressor to perform compressing treatment on the vent gas in polyolefin production so as to meet requirements for operation pressures in condensation separation and membrane separation, a first heat exchanger to perform cooling treatment on the vent gas in polyolefin production after compressing treatment, and a first gas-liquid separator to perform gas-liquid separating treatment on the vent gas in polyolefin production after cooling treatment in sequence.

According to some specific embodiments, along a flow direction of the dry gas stream, the condensation and separation device comprises a second heat exchanger to perform cooling treatment on the dry gas stream and a second gas-liquid separator to perform gas-liquid separating treatment on the dry gas stream after cooling treatment in sequence.

According to some specific embodiments, liquid hydrocarbon flowing from a bottom of the second gas-liquid separator passes through a throttle expansion valve and provides cold energy to the second heat exchanger, and recovered hydrocarbon is output by the second heat exchanger. Noncondensable gas flowing from a top of the second gas-liquid separator provides cold energy to the second heat exchanger, and nitrogen stream (hydrocarbon-depleted) is output by the second heat exchanger.

According to some specific embodiments, the condensation and separation device further comprises external liquid hydrocarbon which provides cold energy to the second heat exchanger, and then recovered hydrocarbon is output by the second heat exchanger.

According to some specific embodiments, the condensation and separation device further comprises a refrigeration unit which is configured to provide cold energy to the second heat exchanger.

According to some specific embodiments, a heat exchanger is one or more selected from a group consisting of a shell-tube heat exchanger, a plate-fin heat exchanger, and a coil-wound heat exchanger.

According to some specific embodiments, the membrane separation device comprises at least one membrane separator in which a membrane module for gas separation is provided.

According to some specific embodiments, when the membrane separation device comprises at least two membrane separators in each of which a membrane module for gas separation is provided, the membrane separators are in series connection to each other along a flow direction of the nitrogen stream (hydrocarbon-depleted) in sequence. The hydrocarbon-enriched gas stream is output from a membrane permeate side of a first membrane separator, and the nitrogen-enriched gas stream is output from a membrane residual side of a last membrane separator.

According to some specific embodiments, the membrane module for gas separation comprises a hydrocarbon selective membrane module and/or a hydrogen selective membrane module.

According to some specific embodiments, the hydrocarbon selective membrane module comprises a hydrocarbon selective membrane, and the hydrocarbon selective membrane is one kind of membrane which is more permeable to hydrocarbon components than to H₂ and N₂. The hydrocarbon selective membrane is preferably a rubbery polymer membrane, such as an organic siloxane polymer membrane.

According to some specific embodiments, the hydrogen selective membrane module comprises a hydrogen selective membrane, and the hydrogen selective membrane is one kind of membrane which is more permeable to H₂ than to N₂ and hydrocarbon components. The hydrogen selective membrane is preferably a glassy polymer membrane, such as polyimide membrane, polyaramide membrane, and polysulfone membrane.

The hydrocarbon selective membrane module and the hydrogen selective membrane module is one or more selected from a group consisting of a spiral-wound membrane module, a plate-frame membrane module, and a hollow fiber membrane module.

According to some specific embodiments, the hydrocarbon-enriched gas stream that is output by the membrane separation device is returned to an inlet of the compressor of the compression device.

According to some specific embodiments, the nitrogen-enriched gas stream that is output by the membrane separation device is returned to a degassing bin of polyolefin plant.

According to the present disclosure, the term “nitrogen stream (hydrocarbon-depleted)” refers to a gas stream in which a content of hydrocarbon in the nitrogen stream is less than 15% (V/V).

According to the present disclosure, the term “hydrocarbon-enriched gas stream” refers to a gas stream in which more than 25% (V/V) is hydrocarbon.

According to the present disclosure, the term “nitrogen-enriched gas stream” refers to a gas stream in which more than 98% (V/V) is nitrogen.

According to the present disclosure, the term “normal temperature” refers to a temperature in a range from 5° C. to 40° C.

According to the present disclosure, the system and the process for recovering valuables from vent gas in polyolefin production can be used for recovering valuables from vent gas in gas-phase olefin polymerization process. The following beneficial effects can be brought about by the present disclosure.

1. By using the drying device in which three adsorption beds are provided, one part of the normal temperature compressed gas stream output by the compression device directly serves as the regeneration gas, and it is unnecessary for the external supply of regeneration gas, whereby the actual recovery of nitrogen can be effectively improved.

2. Heat recovery is considered during the drying step, and thus the energy consumption of the regeneration process can be reduced.

3. The hydrocarbon and nitrogen in the vent gas in polyolefin production can be effectively recovered. The recovery of hydrocarbon is 98% or above; the recovery of nitrogen is 65% or above; and the purity of nitrogen is 98% (V/V) or above.

4. The system can operate stably and reliably and has a low requirement for utility as well as a wider application scope.

### BRIEF DESCRIPTION OF THE DRAWINGS

The present disclosure will be further illustrated hereinafter with reference to the drawings. In the drawings, the same components are represented by the same reference signs.

FIG. 1 schematically shows a structure of an embodiment of a system for recovering valuables from vent gas in polyolefin production according to the present disclosure;

FIG. 2 schematically shows specific structures of two embodiments of a drying device of the system as shown in FIG. 1 according to the present disclosure; and

FIG. 3 schematically shows specific structures of three embodiments of a membrane separation device of the system as shown in FIG. 1 according to the present disclosure.

### DETAILED DESCRIPTION OF THE EMBODIMENTS

The present disclosure will be illustrated in detail hereinafter with reference to the specific embodiments and the drawings. It should be noted that, the terms “first”, “second” and “third” used herein are only for distinguishing the same kinds of devices or substances, but it does not mean difference therebetween in sequence or importance.

FIG. 1 schematically shows a structure of an embodiment of a system for recovering valuables from vent gas in polyolefin production according to the present disclosure. As shown in FIG. 1, the system for recovering valuables from vent gas in polyolefin production comprises a compression device 100, a drying device 200, a condensation and separation device 300 and a membrane separation device 400 that are connected to each other in sequence.

Along a flow direction of the vent gas 10 in polyolefin production, the compression device 100 comprises a vent gas compressor 110, a cooling water cooler 120 and a first gas-liquid separator 130. The vent gas 10 generated in polyolefin production is introduced to an inlet of the vent gas compressor 110 through a pipeline. In the vent gas compressor 110, a pressure of the vent gas is increased to 0.6 MPa to 3.0 MPa so as to meet requirements for operation pressures in following condensation separation and membrane separation steps. The compressed vent gas 11 is transmitted to the cooling water cooler 120 through a pipeline. In the cooling water cooler 120, the compressed vent gas 11 is cooled to normal temperature. Vent gas 12 that is cooled to normal temperature is transmitted to the first gas-liquid separator 130 through a pipeline. In the first gas-liquid separator 130, gas-liquid separation is performed on the vent gas 12 that is cooled to normal temperature. A condensed liquid 20 is obtained at a bottom of the first gas-liquid separator 130 and is output from the compression device 100 through a pipeline. A normal temperature compressed gas stream 13 is obtained at a top of the first gas-liquid separator 130 and is transmitted to the drying device 200 through a pipeline.

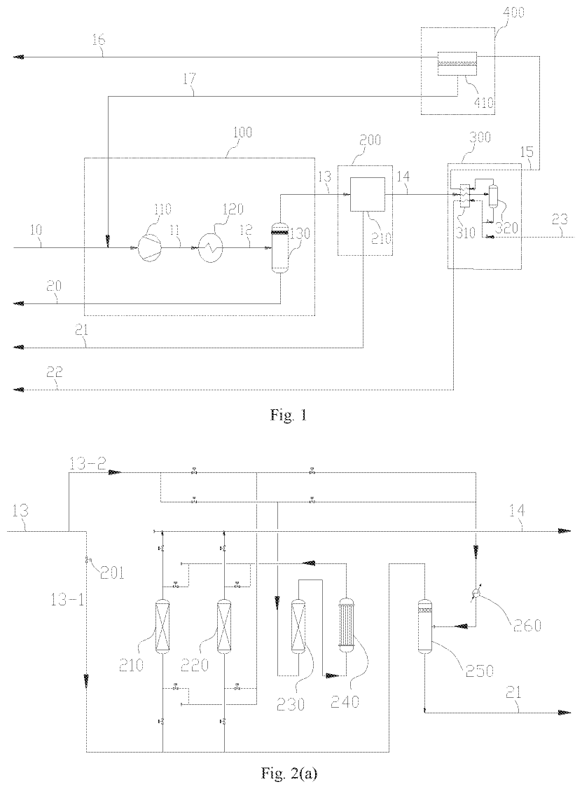

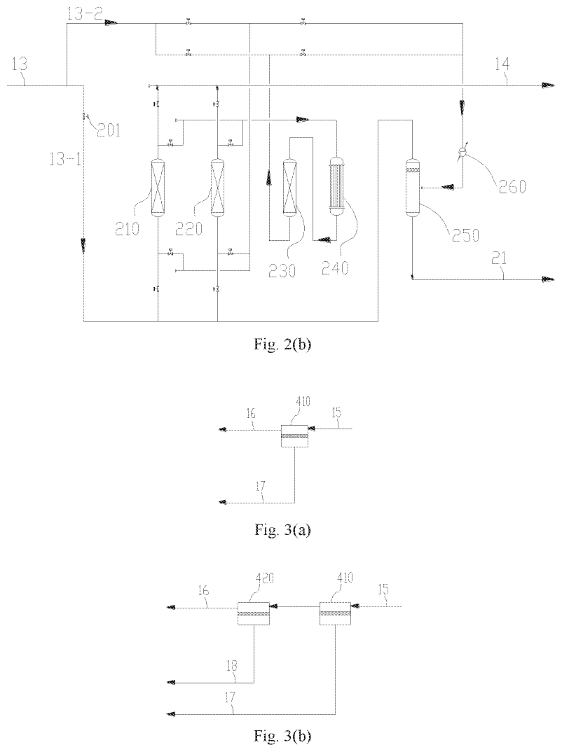

The drying device 200 comprises a first adsorption bed 210 and a second adsorption bed 220 which are in parallel connection with each other and in which a desiccant is provided, a third adsorption bed 230 which is in communication with the first adsorption bed 210 and the second adsorption bed 220 respectively and in which a desiccant is provided, a regeneration gas heater 240 which is in communication with the first adsorption bed 210 and the second adsorption bed 220 respectively, a regeneration gas-liquid separator 250 which is in communication with the first adsorption bed 210 and the second adsorption bed 220 respectively, and a regeneration gas cooler 260 which is in communication with the first adsorption bed 210 and the second adsorption bed 220 respectively. The third adsorption bed 230 is in communication with the regeneration gas heater 240, and the regeneration gas-liquid separator 250 is in communication with the regeneration gas cooler 260, as shown in FIG. 2.

As shown in FIG. 2, the first adsorption bed 210 and the second adsorption bed 220 are configured to be in an adsorption process and a regeneration process alternately, and the third adsorption bed 230 is configured to be in an auxiliary regeneration process.

A flow regulation valve 201 is provided on a pipeline to which the first adsorption bed 210 and the second adsorption bed 220 are in parallel connection with each other and is configured to separate the normal temperature compressed gas stream 13 which enters the drying device 200 into a first gas stream 13-1 and a second gas stream 13-2, and the second gas stream 13-2 directly serves as a regeneration gas stream to regenerate saturated desiccant.

It is assumed that the first adsorption bed 210 is in the adsorption process, while the second adsorption bed 220 has reached adsorption saturation and is in the regeneration process.

The first gas stream 13-1 directly enters into the first adsorption bed 210, and the water therein is adsorbed by molecular sieve desiccant filled in the adsorption bed. After dew point of the gas stream dropping to 0° C. to −60° C., a dry gas stream 14 obtained therein is output by the drying device 200 to the condensation and separation device 300 through a pipeline.

When the second adsorption bed 220 is in a heating process, as shown in FIG. 2(a), the second gas stream 13-2 enters into the third adsorption bed 230 to remove water, and then enters into the regeneration gas heater 240. The gas, after temperature rising, enters into the second adsorption bed 220 for heating process. A temperature of the molecular sieve desiccant in the second adsorption bed 220 rises, and the water adsorbed therein is desorbed. The regenerated gas is cooled by the regeneration gas cooler 260 to normal temperature, and then enters into the regeneration gas-liquid separator 250 for gas-liquid separation. A gas stream output from a top of the regeneration gas-liquid separator 250 and the first gas stream 13-1 are mixed together and enter into the first adsorption bed 210 to be dried. A dry gas stream 14 obtained therein is output by the drying device 200 to the condensation and separation device 300 through a pipeline, and water 21 obtained at a bottom of the regeneration gas-liquid separator 250 is output by the drying device 200 through a pipeline.

After the heating process of the second adsorption bed 220 comes to an end, it enters a cooling process. When the second adsorption bed 220 is in the cooling process, as shown in FIG. 2(b), the second gas stream 13-2 enters into the second adsorption bed 220 to reduce a temperature thereof, and a cooling gas is output by the second adsorption bed 220. The cooling gas enters into the regeneration gas heater 240, and then enters into the third adsorption bed 230 for heating process after temperature rising. A temperature of the molecular sieve desiccant in the third adsorption bed 230 rises, and the water adsorbed therein is desorbed. The regenerated gas is cooled by the regeneration gas cooler 260 to normal temperature, and then enters into the regeneration gas-liquid separator 250 for gas-liquid separation. A gas stream output from a top of the regeneration gas-liquid separator 250 and the first gas stream 13-1 are mixed together and enter into the first adsorption bed 210 to be dried. A dry gas stream 14 obtained therein is output by the drying device 200 to the condensation and separation device 300 through a pipeline, and water 21 obtained at a bottom of the regeneration gas-liquid separator 250 is output by the drying device 200 through a pipeline.

When the first adsorption bed 210 is saturated after adsorption, the valves in pipeline are switched so that the second adsorption bed 220 is in the adsorption process and the first adsorption bed 210 is in the regeneration process.

The status of the three adsorption beds of the drying device according to the present disclosure is shown in Table 1.

TABLE 1
status of the three adsorption beds of the drying device

Time

| | 4.5 h | 3.5 h | 4.5 h | 3.5 h |
|---|---|---|---|---|
| The first | A | A | H | C |
| adsorption bed | | | | |
| The second | H | C | A | A |
| adsorption bed | | | | |
| The third | C | H | C | H |
| adsorption bed | | | | |

As shown in Table 1, A means adsorption, H means heating, and C means cooling.

It can be seen from Table 1 that, the first adsorption bed 210 and the second adsorption bed 220 are in the adsorption process and the regeneration process alternately, and the third adsorption bed 230 is always in heating or cooling auxiliary regeneration process. The regeneration gas heater 240 is always in work. The regeneration gas (i.e., the second gas stream 13-2) absorbs heat from the adsorption bed in the cooling process, and temperature of the regeneration gas is higher than normal temperature, whereby energy consumption of the regeneration gas heater 240 can be reduced.

As shown in FIG. 1, along a flow direction of the dry gas stream 14, the condensation and separation device 300 comprises a second heat exchanger 310 and a second gas-liquid separator 320.

The dry gas stream 14 output by the drying device 200 first enters into the second heat exchanger 310, which is a multi-stream heat exchanger. In the second heat exchanger 310, after the temperature of the dry gas stream 14 is reduced below a hydrocarbon dew point, the dry gas stream 14 enters into the second gas-liquid separator 320 for gas-liquid separation. Liquid hydrocarbon obtained at a bottom of the second gas-liquid separator 320 passes through a throttle expansion valve to reduce the temperature and pressure thereof, and is returned to the second heat exchanger 310 to exchange heat with hot medium in the second heat exchanger 310 and provide cold energy for the hot medium. When the cold energy is not enough, external liquid hydrocarbon 23 performs refrigeration through the throttle expansion valve and provides cold energy for the second heat exchanger 310 so as to ensure that expected condensation temperature is reached. After the liquid hydrocarbon is cooled in the second heat exchanger 310, recovered hydrocarbon 22 is obtained and is output by the condensation and separation device 300. Noncondensable gas obtained at a top of the second gas-liquid separator 320 is returned to the second heat exchanger 310 to exchange heat with the hot medium in the second heat exchanger 310 and provide cold energy for the hot medium. Nitrogen stream (hydrocarbon-depleted) 15 is output by the second heat exchanger 310 and enters into the membrane separation device 400. According to the present disclosure, the condensation and separation device 300 can also be provided with an independent refrigeration unit (not shown in FIG. 1) to provide cold energy for condensation of hydrocarbon in the second heat exchanger 310. In this case, the supplement of external liquid hydrocarbon is unnecessary.

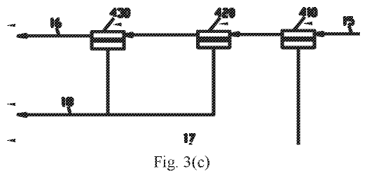

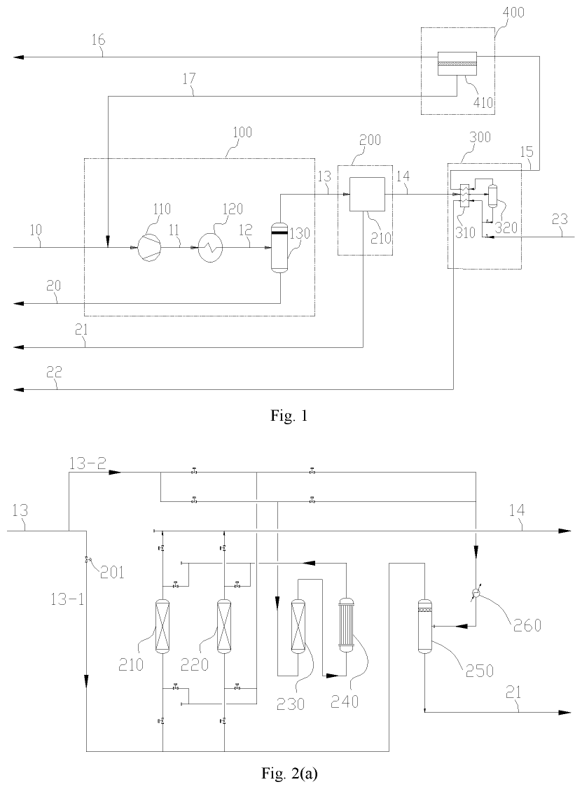

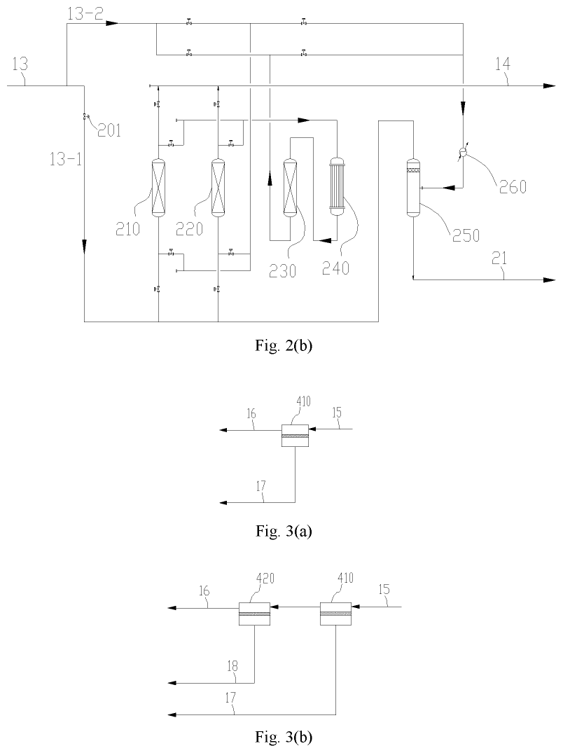

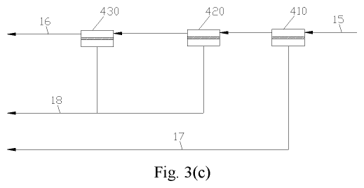

FIG. 3 schematically shows specific structures of three embodiments of the membrane separation device 400 of the system as shown in FIG. 1 according to the present disclosure. As shown in FIG. 3, the membrane separation device 400 comprises at least one membrane separator in which a membrane module for gas separation is provided.

When the membrane separation device comprises only one membrane separator (i.e., a first membrane separator 410), as shown in FIG. 3(a), after the nitrogen stream (hydrocarbon-depleted) 15 is treated by the first membrane separator 410, the hydrocarbon-enriched gas stream 17 is output from permeate side of the first membrane separator 410, and the nitrogen-enriched gas stream 16 is output from residual side of the first membrane separator 410.

When the membrane separation device comprises two or more membrane separators (i.e., a first membrane separator 410, a second membrane separator 420, and a third membrane separator 430), as shown in FIG. 3(b) and FIG. 3(c), the membrane separators are in series connection to each other along a flow direction of the nitrogen stream (hydrocarbon-depleted) in sequence. The hydrocarbon-enriched gas stream 17 is output from permeate side of a first membrane separator, and the nitrogen-enriched gas stream 16 is output from residual side of a last membrane separator.

The hydrocarbon-enriched gas stream 17 that is output by the membrane separation device is returned to an inlet of the vent gas compressor 110 of the compression device 100, and the nitrogen-enriched gas stream 16 that is output by the membrane separation device is returned to a degassing bin of polyolefin plant to be recovered and reused.

According to the present disclosure, recovery of nitrogen can be calculated according to following formula: recovery of nitrogen=S₁₆/S₁₀×100%, wherein S₁₆ is a mass flow of nitrogen in recovered nitrogen stream with a unit of kg/hr, and S₁₀ is a mass flow of nitrogen in vent gas with a unit of kg/hr.

According to the present disclosure, recovery of propylene can be calculated according to following formula: recovery of propylene=[1−S₁₆/S₁₀]×100% (when stream discharged to flare is not contained), or recovery of propylene=[1−(S₁₆+S₁₈)/S₁₀]×100% (when stream discharged to flare is contained), wherein S₁₆ is a mass flow of propylene in recovered nitrogen stream with a unit of kg/hr, S₁₈ is a mass flow of propylene in the stream discharged to flare with a unit of kg/hr, and S₁₀ is a mass flow of propylene in original vent gas with a unit of kg/hr.

### Example 1

The system for recovering valuables from vent gas in polyolefin production as shown in FIG. 1 is used for treating 300,000 tons of vent gas generated in polypropylene plant to recover hydrocarbon and nitrogen.

A pressure of the vent gas in polyolefin production is 0.01 MPa, a temperature is 50° C., a volume flow is 1100 Nm³/hr, and components thereof are shown in Table 2.

TABLE 2
Components of the vent gas of example 1

Components

| | Propylene | Propane | Water | Nitrogen |
|---|---|---|---|---|
| Content % | 25.34 | 4.03 | 1.40 | 69.23 |
| (V/V) | | | | |

The vent gas 10 first enters into the compression device 100. In the compression device 100, the pressure of the vent gas 10 is increased by the vent gas compressor 110 to 2.2 MPa. The compressed vent gas 11 enters into the cooling water cooler 120 to be cooled to 40° C. The cooled vent gas 12 enters into the first gas-liquid separator 130 for gas-liquid separation. The condensed liquid 20 obtained at a bottom of the first gas-liquid separator 130 is output therefrom, and the normal temperature compressed gas stream 13 obtained at a top thereof enters into the drying device 200 through a pipeline. As shown in FIG. 2(a), the drying device 200 comprises three adsorption beds in each of which a molecular sieve desiccant is provided. The first adsorption bed 210 is in the adsorption process; the second adsorption bed 220 is in the heating process; and the third adsorption bed 230 is in the cooling process. The second gas stream 13-2 (i.e., 20 wt % of the normal temperature compressed gas stream 13) serves as the regeneration gas through the flow regulation valve 201. The regeneration gas 13-2 enters into the third adsorption bed 230 to remove water, and then enters into the regeneration gas heater 240. The gas, after temperature rising to 220° C., enters into the second adsorption bed 220 for heating process. A temperature of the molecular sieve desiccant in the second adsorption bed 220 rises, and the water adsorbed therein is desorbed. The regenerated gas is cooled by the regeneration gas cooler 260 to normal temperature, and then enters into the regeneration gas-liquid separator 250 for gas-liquid separation. The condensed water 21 obtained at a bottom of the regeneration gas-liquid separator 250 is output through a pipeline, and a gas stream obtained at a top of the regeneration gas-liquid separator 250 and the first gas stream 13-1 are mixed together and enter into the first adsorption bed 210 to be dried.

A content of H₂O in the vent gas is reduced below 1 ppmv by the adsorption beds to avoid ice blockage in the following condensation and separation steps. The dry gas stream 14 enters into the condensation and separation device 300. The dry gas stream 14 first enters into the second heat exchanger 310 (a multi-stream heat exchanger), and the temperature of the dry gas stream 14 is reduced below −20° C. Then, the dry gas stream 14 enters into the second gas-liquid separator 320 for gas-liquid separation. Liquid hydrocarbon is obtained at a bottom of the second gas-liquid separator 320. The liquid hydrocarbon passes through a throttle expansion valve to reduce the temperature and pressure thereof, and is returned to the second heat exchanger 310 to exchange heat with hot medium and provide cold energy for the hot medium. When the cold energy is not enough, external liquid hydrocarbon 23 performs expansion refrigeration through the throttle expansion valve so as to ensure that expected condensation temperature is reached. The liquid hydrocarbon is changed into recovered hydrocarbon 22 by the second heat exchanger 310 and is output. Noncondensable gas obtained at a top of the second gas-liquid separator 320 is returned to the second heat exchanger 310 to exchange heat with the hot medium and provide cold energy for the hot medium. Nitrogen stream (hydrocarbon-depleted) 15 is output by the second heat exchanger 310 and enters into the membrane separation device 400 through a pipeline.

As shown in FIG. 3(a), the membrane separation device 400 comprises the first membrane separator 410 in which a hydrocarbon selective membrane module is provided. The membrane material used is polyorganosiloxane. The nitrogen stream (hydrocarbon-depleted) 15 passes through the separation membrane, and enriched propylene stream 17 is obtained at a membrane permeate side and returned to the inlet of the vent gas compressor 110. Then, propylene is further recovered through compression and condensation steps. The nitrogen-enriched gas stream 16, in which the purity of nitrogen is larger than 98.5% (V/V), is obtained at a membrane residual side and returned to the degassing bin of the polypropylene plant to be reused.

TABLE 3
Material balance table of example 1

| | Serial number | | | | |
|---|---|---|---|---|---|
| | 10 | 16 | 22 | 21 | 23 |
| | Stream name | | | | |
| | | Recovered | Recovered | Removed | Supplement |
| | Vent gas | nitrogen | propylene | water | propylene coolant |
| | Phase state | | | | |
| | Vapor-phase | Vapor-phase | Vapor-phase | Liquid-phase | Liquid-phase |
| Volume flow | 1100.00 | 756.67 | 429.83 | 15.40 | 101.90 |
| (Nm³/hr) | | | | | |
| Temperature (° C.) | 50.00 | 21.00 | 20.00 | 40.00 | 40.00 |
| Pressure (MPa) | 0.01 | 1.90 | 0.15 | 2.10 | 1.70 |
| Molar percentage | | | | | |
| (%) | | | | | |
| Propylene | 25.34 | 0.71 | 87.21 | 0.00 | 99.60 |
| Propane | 4.03 | 0.10 | 10.23 | 0.00 | 0.40 |
| Nitrogen | 69.23 | 99.19 | 2.56 | 0.00 | 0.00 |
| Water | 1.40 | 0.00 | 0.00 | 100.00 | 0.00 |
| Components | | | | | |
| mass flow (kg/hr) | | | | | |
| Propylene | 516.47 | 9.96 | 694.56 | 0.00 | 188.05 |
| Propane | 86.07 | 1.46 | 85.40 | 0.00 | 0.79 |
| Nitrogen | 939.33 | 925.78 | 13.55 | 0.00 | 0.00 |
| Water | 12.22 | 0.00 | 0.00 | 12.22 | 0.00 |

Based on the material balance data as shown in Table 3, it can be obtained after calculation that, the recovery of propylene of the system is 98.07%, and the recovery of nitrogen is 98.56% with the purity of 99% (V/V) or above. If traditional two-bed dehydration process is used, about 750 kg/hr regeneration nitrogen needs to be consumed according to the present 12.22 kg/hr dehydration load. In this case, the actual recovery of nitrogen is about 18.7%, which is much lower than the recovery of nitrogen of the system disclosed herein.

### Example 2

The system for recovering valuables from vent gas in polyolefin production as shown in FIG. 1 is used for treating 350,000 tons of vent gas generated in polypropylene plant to recover hydrocarbon and nitrogen.

A pressure of the vent gas in polyolefin production is 0.01 MPa, a temperature is 40° C., a volume flow is 1250 Nm³/hr, and components thereof are shown in Table 4.

TABLE 4
Components of the vent gas of example 2

| | Components | | | | |
|---|---|---|---|---|---|
| | Propylene | Propane | Ethylene | Water | Nitrogen |
| Content % | 27.16 | 5.77 | 2.79 | 1.32 | 62.96 |
| (V/V) | | | | | |

The vent gas 10 first enters into the compression device 100. In the compression device 100, the pressure of the vent gas 10 is increased by the vent gas compressor 110 to 2.0 MPa. The compressed vent gas 11 enters into the cooling water cooler 120 to be cooled to 40° C. The cooled vent gas 12 enters into the first gas-liquid separator 130 for gas-liquid separation. The condensed liquid 20 obtained at a bottom of the first gas-liquid separator 130 is output therefrom, and the normal temperature compressed gas stream 13 obtained at a top thereof enters into the drying device 200 through a pipeline. As shown in FIG. 2(a), the drying device 200 comprises three adsorption beds in each of which a molecular sieve desiccant is provided. The first adsorption bed 210 is in the adsorption process; the second adsorption bed 220 is in the heating process; and the third adsorption bed 230 is in the cooling process. The second gas stream 13-2 (i.e., 22 wt % of the normal temperature compressed gas stream 13) serves as the regeneration gas through the flow regulation valve 201. The regeneration gas 13-2 enters into the third adsorption bed 230 to remove water, and then enters into the regeneration gas heater 240. The gas, after temperature rising to 220° C., enters into the second adsorption bed 220 for heating process. A temperature of the molecular sieve desiccant in the second adsorption bed 220 rises, and the water adsorbed therein is desorbed. The regenerated gas is cooled by the regeneration gas cooler 260 to normal temperature, and then enters into the regeneration gas-liquid separator 250 for gas-liquid separation. The condensed water 21 obtained at a bottom of the regeneration gas-liquid separator 250 is output through a pipeline, and a gas stream obtained at a top of the regeneration gas-liquid separator 250 and the first gas stream 13-1 are mixed together and enter into the first adsorption bed 210 to be dried.

A content of H₂O in the vent gas is reduced below 1 ppmv by the adsorption beds to avoid ice blockage in the following condensation and separation steps. The dry gas stream 14 enters into the condensation and separation device 300. The dry gas stream 14 first enters into the second heat exchanger 310, and the temperature of the dry gas stream 14 is reduced below −22° C. Then, the dry gas stream 14 enters into the second gas-liquid separator 320 for gas-liquid separation. Liquid hydrocarbon is obtained at a bottom of the second gas-liquid separator 320. The liquid hydrocarbon passes through a throttle expansion valve to reduce the temperature and pressure thereof, and is returned to the second heat exchanger 310 to exchange heat with hot medium and provide cold energy for the hot medium. When the cold energy is not enough, external liquid hydrocarbon 23 performs expansion refrigeration through the throttle expansion valve so as to ensure that expected condensation temperature is reached. The liquid hydrocarbon is changed into recovered hydrocarbon 22 by the second heat exchanger 310 and is output. Noncondensable gas obtained at a top of the second gas-liquid separator 320 is returned to the second heat exchanger 310 to exchange heat with the hot medium and provide cold energy for the hot medium. Nitrogen stream (hydrocarbon-depleted) 15 is output by the second heat exchanger 310 and enters into the membrane separation device 400 through a pipeline.

As shown in FIG. 3(b), the membrane separation device 400 comprises the first membrane separator 410 and the second membrane separator 420 in each of which a hydrocarbon selective membrane module is provided. The membrane material used is polyorganosiloxane. The nitrogen stream (hydrocarbon-depleted) 15 passes through the separation membrane, and enriched propylene stream 17 is obtained at a membrane permeate side of the first membrane separator 410 and returned to the inlet of the vent gas compressor 110. Then, propylene is further recovered through compression and condensation steps. The gas stream obtained at a membrane residual side of the first membrane separator 410 enters into the second membrane separator 420, and light hydrocarbon components therein, such as methane and ethylene, are separated from nitrogen. The enriched light hydrocarbon components stream 18 is obtained at a membrane permeate side of the second membrane separator 420 and is discharged to a flare. The nitrogen-enriched gas stream 16, in which the purity of nitrogen is larger than 98.5% (V/V), is obtained at a membrane residual side of the second membrane separator 420 and returned to the degassing bin of the polypropylene plant to be reused.

TABLE 5
Material balance table of example 2

| | Serial number | | | | | |
|---|---|---|---|---|---|---|
| | 10 | 16 | 18 | 22 | 21 | 23 |
| | Stream name | | | | | |
| | Vent | Recovered | Components discharged | Recovered | Removed | Supplement |
| | gas | nitrogen | to flare | propylene | water | propylene coolant |
| | Phase state | | | | | |
| | Vapor-phase | Vapor-phase | Vapor-phase | Vapor-phase | Liquid-phase | Liquid-phase |
| Volume flow | 1250.00 | 666.47 | 122.09 | 568.99 | 16.50 | 124.11 |
| (Nm³/hr) | | | | | | |
| Temperature (° C.) | 40.00 | 19.99 | 19.00 | 20.00 | 40.00 | 42.83 |
| Pressure (MPa) | 0.01 | 1.62 | 0.05 | 0.15 | 0.20 | 1.66 |
| Molar percentage | | | | | | |
| (%) | | | | | | |
| Propylene | 27.16 | 0.41 | 3.16 | 80.23 | 0.00 | 99.60 |
| Propane | 5.77 | 0.08 | 0.58 | 12.55 | 0.00 | 0.40 |
| Ethylene | 2.79 | 0.44 | 2.74 | 5.01 | 0.00 | 0.00 |
| Nitrogen | 62.96 | 99.07 | 93.51 | 2.21 | 0.00 | 0.00 |
| Water | 1.32 | 0.00 | 0.00 | 0.00 | 100.00 | 0.00 |
| Components mass | | | | | | |
| flow (kg/hr) | | | | | | |
| Propylene | 629.05 | 5.08 | 7.15 | 845.84 | 0.00 | 229.03 |
| Propane | 140.04 | 0.98 | 1.39 | 138.63 | 0.00 | 0.96 |
| Ethylene | 43.08 | 3.65 | 4.13 | 35.21 | 0.00 | 0.00 |
| Nitrogen | 970.75 | 814.42 | 140.82 | 15.52 | 0.00 | 0.00 |
| Water | 13.09 | 0.00 | 0.00 | 0.00 | 13.09 | 0.00 |

Based on the material balance data as shown in Table 5, it can be obtained after calculation that, the recovery of propylene of the system is 98.05%, and the recovery of nitrogen is 83.9% with the purity of 99% (V/V) or above. If traditional two-bed dehydration process is used, about 800 kg/hr regeneration nitrogen needs to be consumed according to the present 13.09 kg/hr dehydration load. In this case, the actual recovery of nitrogen is about 17.6%, which is much lower than the recovery of nitrogen of the system disclosed herein.

### Example 3

The system for recovering valuables from vent gas in polyolefin production as shown in FIG. 1 is used for treating 350,000 tons of vent gas generated in polypropylene plant to recover hydrocarbon and nitrogen.

A pressure of the vent gas in polyolefin production is 0.01 MPa, a temperature is 40° C., a volume flow is 1380 Nm³/hr, and components thereof are shown in Table 6.

TABLE 6
Components of the vent gas of example 3

| | Components | | | | | | | |
|---|---|---|---|---|---|---|---|---|
| | Propylene | Propane | Ethylene | Ethane | Hydrogen | Water | Nitrogen | Methane |
| Content % | 30.54 | 2.74 | 2.32 | 0.07 | 1.45 | 1.5 | 61.23 | 0.15 |
| (V/V) | | | | | | | | |

The vent gas 10 first enters into the compression device 100. In the compression device 100, the pressure of the vent gas 10 is increased by the vent gas compressor 110 to 2.5 MPa. The compressed vent gas 11 enters into the cooling water cooler 120 to be cooled to 40° C. The cooled vent gas 12 enters into the first gas-liquid separator 130 for gas-liquid separation. The condensed liquid 20 obtained at a bottom of the first gas-liquid separator 130 is output therefrom, and the normal temperature compressed gas stream 13 obtained at a top thereof enters into the drying device 200 through a pipeline. As shown in FIG. 2(a), the drying device 200 comprises three adsorption beds in each of which a molecular sieve desiccant is provided. The first adsorption bed 210 is in the adsorption process; the second adsorption bed 220 is in the heating process; and the third adsorption bed 230 is in the cooling process. The second gas stream 13-2 (i.e., 25 wt % of the normal temperature compressed gas stream 13) serves as the regeneration gas through the flow regulation valve 201. The regeneration gas 13-2 enters into the third adsorption bed 230 to remove water, and then enters into the regeneration gas heater 240. The gas, after temperature rising to 220° C., enters into the second adsorption bed 220 for heating process. A temperature of the molecular sieve desiccant in the second adsorption bed 220 rises, and the water adsorbed therein is desorbed. The regenerated gas is cooled by the regeneration gas cooler 260 to normal temperature, and then enters into the regeneration gas-liquid separator 250 for gas-liquid separation. The condensed water 21 obtained at a bottom of the regeneration gas-liquid separator 250 is output through a pipeline, and a gas stream obtained at a top of the regeneration gas-liquid separator 250 and the first gas stream 13-1 are mixed together and enter into the first adsorption bed 210 to be dried.

A content of H₂O in the vent gas is reduced below 1 ppmv by the adsorption beds to avoid ice blockage in the following condensation and separation steps. The dry gas stream 14 enters into the condensation and separation device 300. The dry gas stream 14 first enters into the second heat exchanger 310, and the temperature of the dry gas stream 14 is reduced below −21° C. Then, the dry gas stream 14 enters into the second gas-liquid separator 320 for gas-liquid separation. Liquid hydrocarbon is obtained at a bottom of the second gas-liquid separator 320. The liquid hydrocarbon passes through a throttle expansion valve to reduce the temperature and pressure thereof, and is returned to the second heat exchanger 310 to exchange heat with hot medium and provide cold energy for the hot medium. When the cold energy is not enough, external liquid hydrocarbon 23 performs expansion refrigeration through the throttle expansion valve so as to ensure that expected condensation temperature is reached. The liquid hydrocarbon is changed into recovered hydrocarbon 22 by the second heat exchanger 310 and is output. Noncondensable gas obtained at a top of the second gas-liquid separator 320 is returned to the second heat exchanger 310 to exchange heat with the hot medium and provide cold energy for the hot medium. Nitrogen stream (hydrocarbon-depleted) 15 is output by the second heat exchanger 310 and enters into the membrane separation device 400 through a pipeline.

As shown in FIG. 3(c), the membrane separation device 400 comprises the first membrane separator 410, the second membrane separator 420, and the third membrane separator 430. A hydrocarbon selective membrane module is provided in the first membrane separator 410 and the second membrane separator 420, and the membrane material used is polyorganosiloxane. A hydrogen selective membrane module is provided in the third membrane separator 430, and the membrane material used is polyimide. The nitrogen stream (hydrocarbon-depleted) 15 passes through the separation membrane, and enriched propylene stream 17 is obtained at a membrane permeate side of the first membrane separator 410 and returned to the inlet of the vent gas compressor 110. Then, propylene is further recovered through compression and condensation steps. The gas stream obtained at a membrane residual side of the first membrane separator 410 enters into the second membrane separator 420, and light hydrocarbon components therein, such as methane, ethylene and ethane, are separated from nitrogen. The gas stream obtained at a membrane residual side of the second membrane separator 420 enters into the third membrane separator 430, and hydrogen is further separated from nitrogen. The hydrogen-enriched stream obtained at a membrane permeate side of the third membrane separator 430 and the light hydrocarbon-enriched stream obtained at a membrane permeate side of the second membrane separator 420 are mixed as a gas stream 18 and discharged to a flare. The nitrogen-enriched gas stream 16, in which the purity of nitrogen is larger than 98.5% (V/V), is obtained at a membrane residual side of the third membrane separator 430 and returned to the degassing bin of the polypropylene plant to be reused.

TABLE 7
Material balance table of example 3

| | Serial number | | | | | |
|---|---|---|---|---|---|---|
| | 10 | 16 | 18 | 22 | 21 | 23 |
| | Stream name | | | | | |
| | Vent | Recovered | Components discharged | Recovered | Removed | Supplement |
| | gas | nitrogen | to flare | propylene | water | propylene coolant |
| | Phase state | | | | | |
| | Vapor-phase | Vapor-phase | Vapor-phase | Vapor-phase | Liquid-phase | Liquid-phase |
| Volume flow | 1380.00 | 564.47 | 298.42 | 620.20 | 20.70 | 123.81 |
| (Nm³/hr) | | | | | | |
| Temperature (° C.) | 40.00 | 16.19 | 19.00 | 20.00 | 40.00 | 42.83 |
| Pressure (MPa) | 0.01 | 1.88 | 0.05 | 0.15 | 0.20 | 1.66 |
| Molar percentage | | | | | | |
| (%) | | | | | | |
| Propylene | 30.54 | 0.28 | 1.73 | 86.75 | 0.00 | 99.60 |
| Propane | 2.74 | 0.02 | 0.14 | 6.09 | 0.00 | 0.40 |
| Ethylene | 2.32 | 0.24 | 1.22 | 4.35 | 0.00 | 0.00 |
| Ethane | 0.07 | 0.01 | 0.02 | 0.14 | 0.00 | 0.00 |
| Hydrogen | 1.45 | 0.29 | 6.05 | 0.05 | 0.00 | 0.00 |
| Nitrogen | 61.23 | 99.02 | 90.53 | 2.56 | 0.00 | 0.00 |
| Water | 1.50 | 0.00 | 0.00 | 0.00 | 100.00 | 0.00 |
| Methane | 0.15 | 0.13 | 0.31 | 0.07 | 0.00 | 0.00 |
| Components mass | | | | | | |
| flow (kg/hr) | | | | | | |
| Propylene | 780.90 | 2.96 | 9.57 | 996.86 | 0.00 | 228.49 |
| Propane | 73.42 | 0.26 | 0.79 | 73.33 | 0.00 | 0.96 |
| Ethylene | 39.55 | 1.70 | 4.50 | 33.32 | 0.00 | 0.00 |
| Ethane | 1.28 | 0.04 | 0.10 | 1.14 | 0.00 | 0.00 |
| Hydrogen | 1.78 | 0.15 | 1.60 | 0.03 | 0.00 | 0.00 |
| Nitrogen | 1042.26 | 689.45 | 333.21 | 19.60 | 0.00 | 0.00 |
| Water | 16.42 | 0.00 | 0.00 | 0.00 | 16.42 | 0.00 |
| Methane | 1.46 | 0.51 | 0.66 | 0.29 | 0.00 | 0.00 |

Based on the material balance data as shown in Table 7, it can be obtained after calculation that, the recovery of propylene of the system is 98.4%, and the recovery of nitrogen is 66.15% with the purity of 99% (V/V) or above. If traditional two-bed dehydration process is used, about 900 kg/hr regeneration nitrogen needs to be consumed according to the present 16.42 kg/hr dehydration load. In this case, the actual recovery of nitrogen is about 13.65%, which is much lower than the recovery of nitrogen of the system disclosed herein.

It can be seen from the above embodiments that, the system and process provided herein can be used for better recovering propylene and nitrogen from vent gas in polyolefin production. The recovery of propylene in the vent gas is higher than 98%; the purity of nitrogen is higher than 98.5% (V/V); and the recovery of nitrogen is higher than 65%. In addition, the system and the process provided herein have the advantages of low investment cost and easy operation.

It should be noted that, the above embodiments are only used for illustrating, rather than restricting the present disclosure. The present disclosure is illustrated hereinabove with reference to typical embodiments, but is can be understood that, the words used herein are descriptive and illustrative ones, rather than restrictive ones. The present disclosure can be amended in the scope of the claims and without departing from the scope and spirit thereof. The present disclosure is described involving specific methods, materials and embodiments, but it does not mean that the present disclosure is limited to the specific embodiments disclosed herein. On the contrary, the present disclosure can be expanded to other methods and applications with the same functions.

1. A system for recovering valuables from vent gas in polyolefin production, comprising:
a compression device, configured to perform compressing, cooling and separating treatments on vent gas in polyolefin production so as to output a condensed liquid and a normal temperature compressed gas stream;
a drying device, connected to the compression device and configured to perform dehydration treatment on the normal temperature compressed gas stream that is output by the compression device so as to output a dry gas stream;
a condensation and separation device, connected to the drying device and configured to perform cooling and separating treatments on the dry gas stream that is output by the drying device so as to output recovered hydrocarbon and nitrogen stream (hydrocarbon-depleted); and
a membrane separation device, connected to the condensation and separation device and configured to perform separating treatment on the nitrogen stream (hydrocarbon-depleted) that is output by the condensation and separation device so as to output a hydrocarbon-enriched gas stream and a nitrogen-enriched gas stream;
wherein the drying device comprises a first adsorption bed and a second adsorption bed which are in parallel connection with each other and in which a desiccant is provided, a third adsorption bed which is in communication with the first adsorption bed and the second adsorption bed respectively and in which a desiccant is provided, a regeneration gas heater which is in communication with the first adsorption bed and the second adsorption bed respectively, a regeneration gas-liquid separator which is in communication with the first adsorption bed and the second adsorption bed respectively, and a regeneration gas cooler which is in communication with the first adsorption bed and the second adsorption bed respectively, the third adsorption bed being in communication with the regeneration gas heater, and the regeneration gas-liquid separator being in communication with the regeneration gas cooler;
wherein the first adsorption bed and the second adsorption bed are configured to be in an adsorption process and a regeneration process alternately, and the third adsorption bed is configured to be in an auxiliary regeneration process; and
wherein a flow regulation valve is provided on a pipeline to which the first adsorption bed and the second adsorption bed are in parallel connection with each other and is configured to separate the normal temperature compressed gas stream into a first gas stream and a second gas stream, and the second gas stream directly serves as a regeneration gas stream to regenerate saturated desiccant.

2. The system according to claim 1, wherein the regeneration process comprises a heating process and a cooling process.

3. The system according to claim 1, wherein when the regeneration process is the heating process, the second gas stream in the normal temperature compressed gas stream is treated by the third adsorption bed, the regeneration gas heater, an adsorption bed in the regeneration process, the regeneration gas cooler, and the regeneration gas-liquid separator in sequence, and then treated by an adsorption bed in the adsorption process mixed with the first gas stream so as to output the dry gas stream.

4. The system according to claim 1, wherein when the regeneration process is the cooling process, the second gas stream in the normal temperature compressed gas stream is treated by an adsorption bed in the regeneration process, the regeneration gas heater, the third adsorption bed, the regeneration gas cooler, and the regeneration gas-liquid separator in sequence, and then treated by an adsorption bed in the adsorption process mixed with the first gas stream so as to output the dry gas stream.

5. The system according to claim 1, wherein a ratio of the second gas stream to the normal temperature compressed gas stream is in a range from 10 wt % to 30 wt %.

6. The system according to claim 1, wherein the desiccant is one or more selected from a group consisting of activated alumina, silica gel, and molecular sieve.

7. The system according to claim 1, wherein along a flow direction of the vent gas in polyolefin production, the compression device comprises a compressor to perform compressing treatment on the vent gas in polyolefin production so as to meet requirements for operation pressures in condensation separation and membrane separation, a first heat exchanger to perform cooling treatment on the vent gas in polyolefin production after compressing treatment, and a first gas-liquid separator to perform gas-liquid separating treatment on the vent gas in polyolefin production after cooling treatment in sequence.

8. The system according to claim 1, wherein along a flow direction of the dry gas stream, the condensation and separation device comprises a second heat exchanger to perform cooling treatment on the dry gas stream and a second gas-liquid separator to perform gas-liquid separating treatment on the dry gas stream after cooling treatment in sequence.

9. The system according to claim 8, wherein liquid hydrocarbon flowing from a bottom of the second gas-liquid separator passes through a throttle expansion valve and provides cold energy to the second heat exchanger, and recovered hydrocarbon is output by the second heat exchanger; and wherein noncondensable gas flowing from a top of the second gas-liquid separator provides cold energy to the second heat exchanger, and nitrogen stream (hydrocarbon-depleted) is output by the second heat exchanger.

10. The system according to claim 1, wherein the condensation and separation device further comprises external liquid hydrocarbon which provides cold energy to the second heat exchanger, and then recovered hydrocarbon is output by the second heat exchanger.

11. The system according to claim 1, wherein the condensation and separation device further comprises a refrigeration unit which is configured to provide cold energy to the second heat exchanger.

12. The system according to claim 1, wherein a heat exchanger is one or more selected from a group consisting of a shell-tube heat exchanger, a plate-fin heat exchanger, and a coil-wound heat exchanger.

13. The system according to claim 1, wherein the membrane separation device comprises at least one membrane separator in which a membrane module for gas separation is provided.

14. The system according to claim 13, wherein when the membrane separation device comprises at least two membrane separators in each of which a membrane module for gas separation is provided, the membrane separators are in series connection to each other along a flow direction of the nitrogen stream (hydrocarbon-depleted) in sequence; and wherein the hydrocarbon-enriched gas stream is output from a membrane permeate side of a first membrane separator, and the nitrogen-enriched gas stream is output from a membrane residual side of a last membrane separator.

15. The system according to claim 13, wherein the membrane module for gas separation comprises a hydrocarbon selective membrane module and/or a hydrogen selective membrane module.

16. The system according to claim 15, wherein the hydrocarbon selective membrane module comprises a hydrocarbon selective membrane, and the hydrocarbon selective membrane is preferably a rubbery polymer membrane; and wherein the hydrogen selective membrane module comprises a hydrogen selective membrane, and the hydrogen selective membrane is preferably a glassy polymer membrane.

17. The system according to claim 1, wherein the hydrocarbon-enriched gas stream that is output by the membrane separation device is returned to an inlet of the compressor of the compression device.

18. The system according to claim 1, wherein the nitrogen-enriched gas stream that is output by the membrane separation device is returned to a degassing bin of polyolefin plant.

19. A process for recovering valuables from vent gas in polyolefin production, comprising steps of:
performing, in a compression device, compressing, cooling and separating treatments on vent gas in polyolefin production so as to output a condensed liquid and a normal temperature compressed gas stream;
performing, in a drying device that is connected to the compression device, dehydration treatment on the normal temperature compressed gas stream that is output by the compression device so as to output a dry gas stream;
performing, in a condensation and separation device that is connected to the drying device, cooling and separating treatments on the dry gas stream that is output by the drying device so as to output recovered hydrocarbon and nitrogen stream (hydrocarbon-depleted); and
performing, in a membrane separation device that is connected to the condensation and separation device, separating treatment on the nitrogen stream(hydrocarbon-depleted) that is output by the condensation and separation device so as to output a hydrocarbon-enriched gas stream and a nitrogen-enriched gas stream;
wherein the drying device comprises a first adsorption bed and a second adsorption bed which are in parallel connection with each other and in which a desiccant is provided, a third adsorption bed which is in communication with the first adsorption bed and the second adsorption bed respectively and in which a desiccant is provided, a regeneration gas heater which is in communication with the first adsorption bed and the second adsorption bed respectively, a regeneration gas-liquid separator which is in communication with the first adsorption bed and the second adsorption bed respectively, and a regeneration gas cooler which is in communication with the first adsorption bed and the second adsorption bed respectively, the third adsorption bed being in communication with the regeneration gas heater, and the regeneration gas-liquid separator being in communication with the regeneration gas cooler;
wherein the first adsorption bed and the second adsorption bed are configured to be in an adsorption process and a regeneration process alternately, and the third adsorption bed is configured to be in an auxiliary regeneration process; and
wherein a flow regulation valve is provided on a pipeline to which the first adsorption bed and the second adsorption bed are in parallel connection with each other and is configured to separate the normal temperature compressed gas stream into a first gas stream and a second gas stream, and the second gas stream directly serves as a regeneration gas stream to regenerate saturated desiccant.

20. The process according to claim 19, wherein the regeneration process comprises a heating process and a cooling process.

21. The process according to claim 19, wherein when the regeneration process is the heating process, the second gas stream in the normal temperature compressed gas stream is treated by the third adsorption bed, the regeneration gas heater, an adsorption bed in the regeneration process, the regeneration gas cooler, and the regeneration gas-liquid separator in sequence, and then treated by an adsorption bed in the adsorption process mixed with the first gas stream so as to output the dry gas stream.

22. The process according to claim 19, wherein when the regeneration process is the cooling process, the second gas stream in the normal temperature compressed gas stream is treated by an adsorption bed in the regeneration process, the regeneration gas heater, the third adsorption bed, the regeneration gas cooler, and the regeneration gas-liquid separator in sequence, and then treated by an adsorption bed in the adsorption process mixed with the first gas stream so as to output the dry gas stream.

23. The process according to claim 19, wherein a ratio of the second gas stream to the normal temperature compressed gas stream is in a range from 10 wt % to 30 wt %.

24. The process according to claim 19, wherein the desiccant is one or more selected from a group consisting of activated alumina, silica gel, and molecular sieve.

25. The process according to claim 19, wherein along a flow direction of the vent gas in polyolefin production, the compression device comprises a compressor to perform compressing treatment on the vent gas in polyolefin production so as to meet requirements for operation pressures in condensation separation and membrane separation, a first heat exchanger to perform cooling treatment on the vent gas in polyolefin production after compressing treatment, and a first gas-liquid separator to perform gas-liquid separating treatment on the vent gas in polyolefin production after cooling treatment in sequence.

26. The process according to claim 19, wherein along a flow direction of the dry gas stream, the condensation and separation device comprises a second heat exchanger to perform cooling treatment on the dry gas stream and a second gas-liquid separator to perform gas-liquid separating treatment on the dry gas stream after cooling treatment in sequence.

27. The process according to claim 26, wherein liquid hydrocarbon flowing from a bottom of the second gas-liquid separator passes through a throttle expansion valve and provides cold energy to the second heat exchanger, and recovered hydrocarbon is output by the second heat exchanger; and wherein noncondensable gas flowing from a top of the second gas-liquid separator provides cold energy to the second heat exchanger, and nitrogen stream (hydrocarbon-depleted) is output by the second heat exchanger.

28. The process according to claim 19, wherein the condensation and separation device further comprises external liquid hydrocarbon which provides cold energy to the second heat exchanger, and then recovered hydrocarbon is output by the second heat exchanger.

29. The process according to claim 19, wherein the condensation and separation device further comprises a refrigeration unit which is configured to provide cold energy to the second heat exchanger.

30. The process according to claim 19, wherein a heat exchanger is one or more selected from a group consisting of a shell-tube heat exchanger, a plate-fin heat exchanger, and a coil-wound heat exchanger.

31. The process according to claim 19, wherein the membrane separation device comprises at least one membrane separator in which a membrane module for gas separation is provided.

32. The process according to claim 31, wherein when the membrane separation device comprises at least two membrane separators in each of which a membrane module for gas separation is provided, the membrane separators are in series connection to each other along a flow direction of the nitrogen stream (hydrocarbon-depleted) in sequence; and wherein the hydrocarbon-enriched gas stream is output from a membrane permeate side of a first membrane separator, and the nitrogen-enriched gas stream is output from a membrane residual side of a last membrane separator.

33. The process according to claim 31, wherein the membrane module for gas separation comprises a hydrocarbon selective membrane module and/or a hydrogen selective membrane module.

34. The process according to claim 33, wherein the hydrocarbon selective membrane module comprises a hydrocarbon selective membrane, and the hydrocarbon selective membrane is preferably a rubbery polymer membrane; and wherein the hydrogen selective membrane module comprises a hydrogen selective membrane, and the hydrogen selective membrane is preferably a glassy polymer membrane.

35. The process according to claim 19, wherein the hydrocarbon-enriched gas stream that is output by the membrane separation device is returned to an inlet of the compressor of the compression device.

36. The process according to claim 19, wherein the nitrogen-enriched gas stream that is output by the membrane separation device is returned to a degassing bin of polyolefin plant.
